(19) United States
(12) Patent Application Publication
(10) Pub. No.: US 2013/0120282 A1
(43) Pub. Date: May 16, 2013

(54) System and Method for Evaluating Gesture Usability

(71) Applicant: Tim Kukulski, Oakland, CA (US)

(72) Inventor: Tim Kukulski, Oakland, CA (US)

(21) Appl. No.: 12/957,292

(22) Filed: Nov. 30, 2010

Related U.S. Application Data
(63) Continuation-in-part of application No. 12/789,743, filed on May 28, 2010.

(51) Int. Cl. G06F 3/041

(52) U.S. Cl. 345/173

(57) ABSTRACT

Various embodiments of a system for evaluating gesture usability are described. A gesture evaluator may perform a geometric analysis of the physical characteristics of a gesture to determine a geometry rating for the touch gesture. The gesture evaluator may determine a similarity rating for the gesture by analyzing the similarity of the gesture to other gestures. The gesture evaluator may evaluate repeated user executions of the gesture to determine a repeatability rating for the gesture. Dependent on one or more of the geometry rating, the similarity rating and the repeatability rating, the gesture evaluator may calculate a usability rating for the gesture. The usability rating for the gesture may indicate the probability that a user will execute the gesture correctly. The gesture evaluator may also calculate an accessibility rating, which may indicate the probability that a user with reduced motor skills will execute the gesture correctly.

### PRIORITY INFORMATION

This application is a continuation-in-part of U.S. application Ser. No. 12/789,743 entitled “System and Method for Evaluating Interoperability of Gesture Recognizers” filed May 28, 2010, the content of which is incorporated by reference herein in its entirety.

### BACKGROUND

Touch gesture technology provides hardware and software that allows computer users to control various software applications via the manipulation of one or more digits (e.g., finger(s) and/or thumb) on a touch-sensitive surface of a touch-enabled device. Touch gesture technology generally consists of a touch-enabled device such as a touch-sensitive display device (computer display, screen, table, wall, etc.) for a computing system (desktop, notebook, touchpad, tablet, etc.), as well as software that recognizes multiple, substantially simultaneous touch points on the surface of the touch-enabled device.

As touch gesture technology becomes more widely used, particularly by novice users, the ease of use, or usability, of touch gestures needs to be evaluated. Users will experience frustration and a decrease in efficiency when attempting to execute touch gestures that are difficult to execute, too similar to other touch gestures, or are difficult to learn. Conventional methods do not provide a mechanism for evaluating the ease of use of a touch gesture, evaluating the similarity of a touch gesture to other touch gestures, or evaluating how easily a touch gesture may be learned by users.

### SUMMARY

Various embodiments of a system and methods for evaluating gesture usability are described. A method for evaluating gesture usability may include receiving geometry data for a gesture. The geometry data for the gesture may indicate the physical characteristics of the gesture. As an example, the geometry data may indicate the physical characteristics of a touch gesture. The physical characteristics of the touch gesture may include one or more of a number of touch points of the touch gesture, coordinate positions of the touch points and shape of the touch gesture.

The method for evaluating gesture usability may include analyzing the geometry data for the gesture. For example, the geometry data for the gesture may be compared to a library of gesture rules. The method may further include calculating, dependent on the analysis of the geometry data for the gesture, a usability rating for the gesture. The usability rating may indicate the probability that a user will execute the gesture correctly.

### BRIEF DESCRIPTION OF THE DRAWINGS

FIG. 1 illustrates an example of a gesture evaluator which may be configured to evaluate gesture usability, according to some embodiments.

FIGS. 2A and 2B illustrate examples of touch gestures with different geometry ratings, according to some embodiments.

FIG. 3 illustrates an example of a method that may be used to determine a usability rating for a touch gesture, according to some embodiments.

FIG. 4 illustrates an example of a method that may be used to calculate a geometry rating for a touch gesture, according to some embodiments.

FIG. 5 illustrates an example computer system that may be used in embodiments.

While the invention is described herein by way of example for several embodiments and illustrative drawings, those skilled in the art will recognize that the invention is not limited to the embodiments or drawings described. It should be understood, that the drawings and detailed description thereto are not intended to limit the invention to the particular form disclosed, but on the contrary, the intention is to cover all modifications, equivalents and alternatives falling within the spirit and scope of the present invention. The headings used herein are for organizational purposes only and are not meant to be used to limit the scope of the description. As used throughout this application, the word “may” is used in a permissive sense (e.g., meaning having the potential to), rather than the mandatory sense (e.g., meaning must). Similarly, the words “include”, “including”, and “includes” mean including, but not limited to.

### DETAILED DESCRIPTION OF EMBODIMENTS

Various embodiments of a system and methods for evaluating gesture usability are described herein. In the following detailed description, numerous specific details are set forth to provide a thorough understanding of claimed subject matter. However, it will be understood by those skilled in the art that claimed subject matter may be practiced without these specific details. In other instances, methods, apparatuses or systems that would be known by one of ordinary skill have not been described in detail so as not to obscure claimed subject matter.

Some portions of the detailed description which follow are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and is generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

Various embodiments of a system and methods for evaluating gesture usability are described herein. For simplicity, embodiments of the system and methods for evaluating gesture usability described herein will be referred to collectively as a gesture evaluator. A gesture evaluator may evaluate the usability of a gesture definition. For example, a gesture evaluator may provide feedback to a developer regarding the usability of a gesture definition prior to its implementation. A gesture evaluator may be distinct from a gesture recognizer. A gesture evaluator may include a system by which abstract gesture definitions are analyzed individually and/or collectively to predict usability and accessibility of the gesture definitions. A gesture recognizer may provide for the implementation of a gesture definition. For example a gesture recognizer may be implement gesture definitions at a user device to interpret user gesture inputs at the device. A gesture recognizer may convert low-level user actions into high-level events by recognizing the intent of the user actions, and may be implemented in terms of an abstract gesture definition. Concrete gesture recognizers may be tested individually and collectively to gather statistical data about usability and accessibility. The information associated with the use of gesture recognizers may used by a gesture evaluator to provide feedback regarding proposed gesture definitions. Feedback may include predictions of how well a proposed gesture may be implemented and/or guidance to improve the quality of the gesture definition to thereby improve a developer's work product. For example, usage history gathered from gesture recognizers, such as information regarding gesture input errors, may be used to provide a prediction as to whether or not a proposed gesture will lead to input errors if implemented. Exemplary embodiments of the gesture evaluator will be described herein as a system for evaluating the usability of touch gestures, which may be gestures applied to the surface of a touch-enabled device and/or gestures made in the space proximate a gesture sensing device. Note that the example of evaluating touch gestures is not meant to be limiting, as other embodiments of the gesture evaluator may evaluate gesture types other than, or in addition to, touch gestures.

The gesture evaluator may be configured to evaluate gestures for an input device that is configured to sense non-touch gestural motions at multiple locations. For example, the gesture evaluator may be configured to evaluate gestures for an input device that is configured to sense touch gestural motions in multi-dimensional space. An example of such an input device may be a device that is configured to sense non-touch gestures that are performed while hovering over a surface, rather than directly contacting the surface. In some embodiments, the gestural motions in multi-dimensional space that do not include touching or near touching with a device may be referred to as non-touch gestures. In some embodiments, gestural motions may be sensed via a depth camera or similar device having a three-dimensional (3D) sensor capable of capturing motions (e.g., gestures) in three dimensions. Such a 3D sensing device may be capable of sensing gestures in contact with the sensor or in the space proximate to or some distance from the sensor. For example, a 3D sensing device may be capable of sensing gestures in contact with an input sensor (e.g., screen), gestures in near contact the input sensor (e.g., hovering within a few inches of the sensor/screen), or gestures in the environment space around the input sensor (e.g., gesture by a user in the same room as the device). In some embodiments, a combination of touch and non-touch gesture inputs may be used to provide for efficient user input. For example, touch-gestures may be used to provide for marking (e.g., editing text within the document) in a displayed document while non-touch gestures may be used to navigate (e.g., pan or zoom) within the document, thereby reducing the likelihood of a user accidentally marking a document while attempting to simply navigate within the document. Other examples of non-touch gestural input devices that may be supported by the gesture evaluator are accelerometer-based motion input devices and input devices that sense motion within a magnetic field. Other input device technologies for recognizing non-touch gestural motions may also be supported. The input devices may receive input via physical buttons and/or touch-sensitive surfaces. As yet another example, the gesture evaluator may be configured to evaluate gestures for any type of computing input device which may indicate a gesture, such as a stylus input applied to a tablet PC. The gesture evaluator may support any combination of touch-sensitive and/or non-touch gesture for gestural input devices that may be operating concurrently to sense gestural input. Although embodiments described herein may refer to a gesture input via touch (e.g., touch gesture) and/or gestures sensed via other techniques (e.g., non-touch gesture), it will be appreciated that the techniques described herein with regard to gestures may be applied to gestures including touch and/or non-touch gestures. For example, processing techniques relating to a touch gesture sensed via a path of a user's finger as it is moved in-contact with a touch screen may be similarly applied to a non-touch gesture via a path of a user's finger as it is moved in-near contact (e.g., hovered) proximate a sensing device and/or moved in the environmental space proximate or distal from the sensor. That is, embodiments described herein with respect to touch gestures may be similarly applied to non-touch gestures or gestures that are a combination of touch and non-touch gestures.

Some embodiments of the gesture evaluator, as described herein, may evaluate the usability of a touch gesture by determining how difficult, or how easy, the touch gesture may be for a user to execute, for example, on, or proximate to, the surface of a touch-enabled device. The usability rating of a touch gesture may indicate the probability that a user will execute the touch gesture correctly. In some embodiments, the usability rating may also indicate the risk/likelihood of a user accidentally executing the given gesture while attempting to perform another action. The gesture evaluator may evaluate several characteristics of a touch gesture to determine the usability of the touch gesture. For example, the gesture evaluator may perform analysis (e.g., geometric analysis, timing analysis, device capabilities analysis and/or accessibility analysis) of the physical characteristics of a touch gesture. As another example, the gesture evaluator may evaluate the similarity of the touch gesture to other touch gestures. As yet another example, the gesture evaluator may evaluate the repeatability of the touch gesture. The evaluation of the repeatability of the touch gesture may include performing real-time user tests, stored recordings of user actions, or simulated user actions based on ergonomic models of the human body. Processing may be applied to the stored recordings of user actions to simulate users with varying physical capabilities. Processing may be applied to stored recordings or ergonomic simulations in order to simulate the capabilities of a particular input system. This can be used to simulate both systems that have tighter input limitations (e.g., the ability to receive only two touches simultaneously) or to simulate systems that have fewer limitations (e.g., a system that supports ability to receive ten touches simultaneously, with an indication of pressure for one or more of the respective ten touches). In some embodiments, the geometric analysis, the similarity evaluation, and/or the repeatability evaluation may be based on a comparison of a gesture to user profiles indicative user's experience and dexterity such that the gesture can be evaluated in the context of user's experience level and dexterity. The usability of the touch gesture may be determined dependent on any combination of the geometric analysis, the similarity evaluation, and/or the repeatability evaluation. In some embodiments the usability of the touch gesture may be dependent on other characteristics of the touch gesture. In some embodiments, usability may provide an indication as to whether or not two-dimensional gestures (e.g., touch gestures) interoperate well with three-dimensional gestures (e.g., non-touch gestures). For example, usability may indicate that is predicted to be difficult for a user to first provide a hovering gesture that is followed by a gesture that includes contacting the screen.

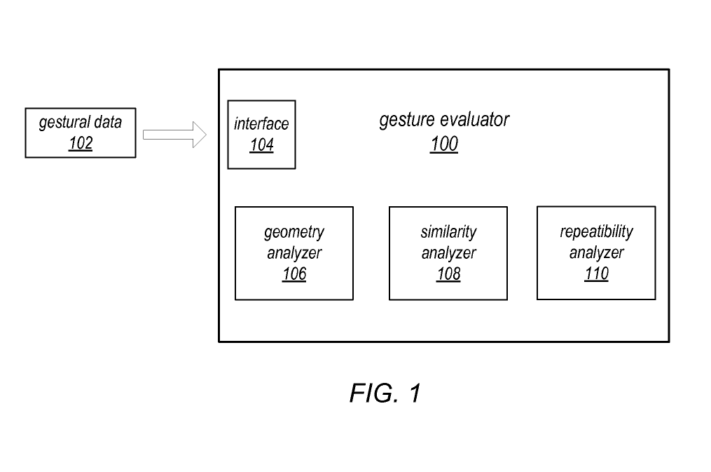

The system for evaluating gesture usability may be implemented as a gesture evaluator. Embodiments of a gesture evaluator, which may be implemented as or in a tool, module, plug-in, stand-alone application, etc., may be used to evaluate touch gestures applied to a touch-enabled device FIG. 1 illustrates an example of a gesture evaluator 100 which may be configured to evaluate gesture usability. As illustrated in FIG. 1, gesture evaluator 100 may receive gestural data 102 via interface 104. Gestural data 102 may include a definition of a gesture (e.g., touch or non-touch gesture), for example, in a gesture definition language. The gesture may be indicative of a proposed gesture provided by a user that desires to receive an indication of the usability of the proposed gesture. Gestural data 102 may also include gesture event data which represents user-executed gestures. For example, a user may execute a touch gesture on a touch-enabled device. Gesture event data which represents the touch gesture may be captured by a device driver of the touch-enabled device and sent, as gestural data 102, to gesture evaluator 100. Gesture evaluator 100 may receive the gesture event data from the device driver via interface 104.

As illustrated in FIG. 1, gesture evaluator 100 may include geometry analyzer 106, similarity analyzer 108 and repeatability analyzer 110. Geometry analyzer 106 may be configured to perform analysis (e.g., geometric analysis, timing analysis, device capabilities analysis and/or accessibility analysis) of the physical characteristics of a touch gesture. Similarity analyzer 108 may be configured to evaluate the similarity of the touch gesture to other touch gestures. Repeatability analyzer 110 may be configured to evaluate the repeatability of the touch gesture. Gesture evaluator 100 may determine the usability of a touch gesture dependent on results from any combination of geometry analyzer 106, similarity analyzer 108 and repeatability analyzer 110.

As described above, a touch gesture may be evaluated to determine a level of usability for the touch gesture. As described herein, a level of usability for a touch gesture may indicate the probability that a user will execute the touch gesture correctly. In other words, a level of usability for a touch gesture may indicate how difficult, or how easy, the gesture is for a user to physically execute. For simplicity, a level of usability for a touch gesture may be referred to herein as a usability rating. Gesture evaluator 100 may use a set of heuristics to calculate a usability rating for a touch gesture. A usability rating for a touch gesture may be dependent on any combination of the geometry of the gesture (e.g., the physical characteristics of the gesture), the similarity of the gesture to other gestures (e.g., the distinctiveness of the touch gesture), and the ability of users to learn the touch gesture and successfully repeat multiple iterations of the touch gesture (e.g., repeatability). Gesture evaluator 100 may calculate, for a touch gesture, a geometry rating based on the physical characteristics of the touch gesture, a similarity rating based on the distinctive nature of the touch gesture and a repeatability rating based on the repeatability of the touch gesture. A usability rating for the touch gesture may be calculated based on any one of, or any combination of, the geometry rating, the similarity rating, and/or the repeatability rating of the gesture.

A geometry rating for a touch gesture may be dependent on the physical characteristics of the touch gesture. Some examples of the physical characteristics of a touch gesture may be a number of touch points, spacing (e.g., coordinate positions) between the touch points, and the path, or shape, of the touch gesture. The physical characteristics of a touch gesture may dictate how difficult, or how easy, the touch gesture may be for a user to execute. For example, if the touch gesture requires a large number of touch points, touch points which are in close spatial proximity, and/or execution of a complex curvature pattern, the gesture may be difficult for a user to execute correctly. In such an example, the touch gesture may have a low geometry rating. As another example, a touch gesture that requires a simple movement using a single touch point may have a high geometry rating. Geometry rating may also take into account a usability with regard to a particular device or group of devices. For instance, some gestures may require access to properties of a touch that are not available on all systems due to the number of touches available, the quality of touch detection on a given system, or the properties available within a given event from the sensor. For example, a three-finger gesture may not be usable on systems that only support two touches. Similarly, systems that have “ghost touches” (sometimes referred to as 1 ½ touch systems) might only be able to use some two-touch gestures. In some embodiments, the usability with regard to a particular device is factored into the geometry rating and/or provides as a separate usability evaluation of the gesture. Thus, taking into account a usability of a gesture with regard to one or more types of devices and/or systems may further assist developers in creating gesture definitions that are usable with a wide range of devices as well as users.

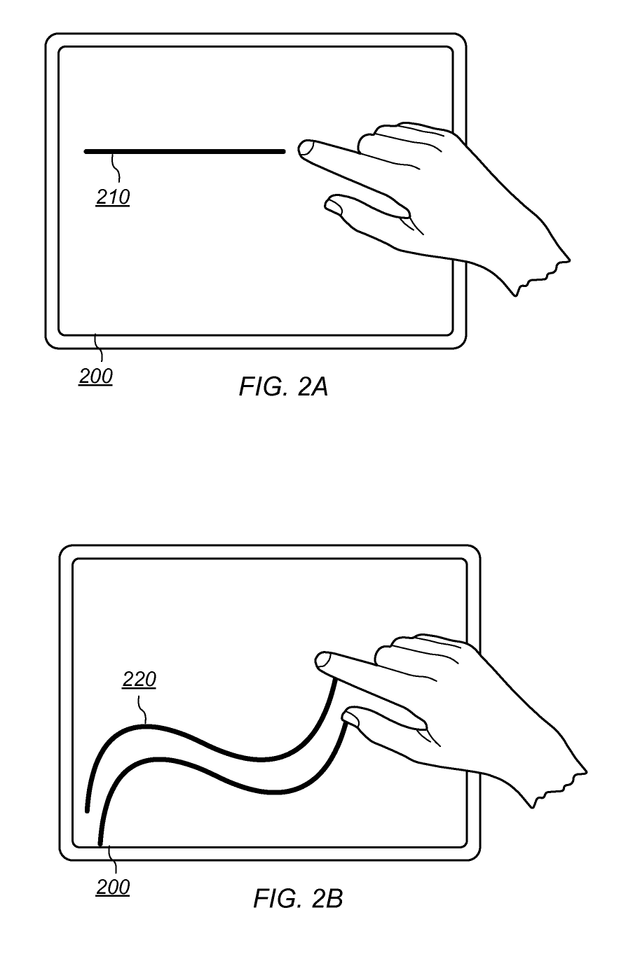

FIGS. 2A and 2B illustrate examples of touch gestures with different geometry ratings, according to some embodiments. FIG. 2A illustrates an example of a touch gesture, 210, that may be applied to the surface, 200, of a touch-enabled device. Touch gesture 210 is a simple movement that is a horizontal swipe across the surface of the touch-enabled device with a single finger. Touch gesture 210 may have a high geometry rating. FIG. 2B illustrates an example of a touch gesture, 220, that may be applied to the surface, 200, of a touch-enabled device. Touch gesture 220 is a more complicated movement which includes multiple direction changes and is executed by a finger and thumb in close proximity on the surface of the touch-enabled device. Touch gesture 220 may have a lower geometry rating than touch gesture 210.

Geometry analyzer 106 may analyze the physical characteristics (e.g., geometry) of a touch gesture (e.g., touch gesture 210 and/or 220) to calculate a geometry rating for the touch gesture. Similarity analyzer 108 may compare the physical characteristics of the touch gesture to the physical characteristics of other touch gestures to calculate a similarity rating for the touch gesture. Repeatability analyzer 110 may record and analyze the results of multiple users executing repeated iterations of the touch gesture. The evaluation of the repeatability of the touch gesture may include performing real-time user tests, stored recordings of user actions, or simulated user actions based on ergonomic models of the human body. Processing may be applied to the stored recordings of user actions to simulate users with varying physical capabilities. Processing may include manual editing of an event stream or the merging of two independent event streams. For example, two independent gesture event streams may be merged to form a single gesture event stream. Processing may be applied to stored recordings or ergonomic simulations in order to simulate the capabilities of a particular input system. This can be used to simulate both systems that have tighter limitations (e.g., only two touches) or to simulate systems that have fewer limitations (e.g., a system that supports ten touches, with pressure). Dependent on the ability of the multiple users to successfully execute the touch gesture during multiple, repeated iterations, repeatability analyzer 110 may calculate a repeatability rating for the gesture. Based on a statistical analysis of the results of the geometric evaluation, the comparison to other gestures and user execution of the gesture, gesture evaluator 100 may determine a usability rating for the touch gesture.

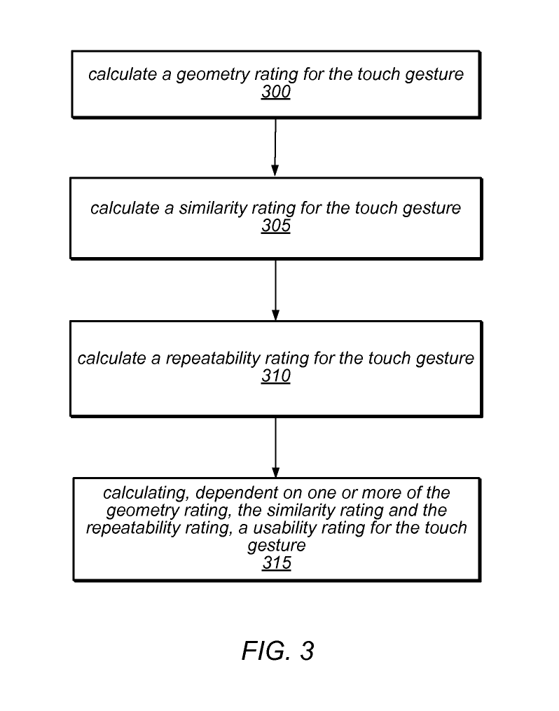

Gesture evaluator 100 may be configured to perform a method such as the method illustrated in FIG. 3 to determine a usability rating for a touch gesture. As shown at 300, the method illustrated in FIG. 3 may include calculating a geometry rating for the touch gesture. Geometry analyzer 106 may analyze the physical characteristics of a touch gesture to evaluate and rate the geometry of the gesture. The physical characteristics of a touch gesture may define the geometry, or shape of the gesture.

Examples of physical characteristics that may define the geometry of a touch gesture may include, but are not limited to: the number of touch points (e.g., number of contact points with the surface of a touch-enabled device), touch point locations (e.g., coordinate positions of the touch points), relative distance between touch points, trajectory of each touch point, amount of pressure applied at each touch point, speed of trajectories (e.g., speed of the touch gesture's motion), area of contact of each touch point, timeline (e.g., beginning, progression and end of the touch gesture), and scale (e.g., the radius of a circular touch gesture).

The types of touch gesture characteristics supported by touch-enabled devices may vary between different types of devices. For example, some touch-enabled devices may support a set of common touch gesture characteristics such as touch point locations, speed and direction. Other touch-enabled devices may support an extended set of touch gesture characteristics which may include, in addition to the common touch gesture characteristics, an extended set of characteristics such as number of digits used (multi-touch gestures), amount of pressure applied at touch points, and area of contact of each touch point. The gesture test system may evaluate touch gestures based on both a set of common touch gesture characteristics and a set of extended touch gesture characteristics. Gesture characteristics that may be provided in a set of common and/or extended set of gesture characteristics may include, but are not limited to: sampling rate, noise level/spatial resolution, minimum detail, latency, availability of extended event properties and/or gross characteristics of a device.

Sampling rate may characterize the sampling rate used for sensing a gesture. For example, contact to a screen of a touch device may be sensed/sampled every one-hundredth of a second for a sampling rate of one hundred samples per second. High sampling rates may enabled a more detailed representation of the gesture to be sensed and generated, where as low sampling rates may reduced the sensed and generated detail of the gesture. For example, if a system cannot sense/process touch events quickly enough, the system will not be able to reliably track the user's velocity and acceleration, thereby providing a less detailed representation of the gesture for recognition. Gestures more dependent on the fine-grained timing of events may require higher sampling rates, and may be subject to a lower rating based on the inability of the gesture to be implemented on an increasing number of devices. Gestures less dependent on the fine-grained timing of events may not require higher sampling rates, and may be subject to a higher rating based on the ability of the gesture to be implemented on an increasing number of devices. Such a sampling rate analysis may be provided as an aspect of geometric and and/or time-based analysis of geometric definitions, and may be provided by geometry analyzer 106.

Noise level and/or spatial resolution may characterize the ability of a device distinguish small thresholds of movement and/or smooth movements. Systems with a poor signal-to-noise ratio or poor spatial resolution may have difficultly distinguishing gestures that include small thresholds of movement and/or smooth movements. Gestures dependent on small thresholds of movement and/or smooth movements may require better signal-to-noise ratios and/or increased spatial resolution, and may be subject to a lower rating based on the inability of the gesture to be implemented on certain devices. Such a noise level/spatial analysis may be provided as an aspect of geometric and and/or time-based analysis of geometric definitions, and may be provided by geometry analyzer 106. Minimum detail may characterize the ability of a device to distinguish points within a given distance of one another. Some devices are generally incapable of distinguishing points that are within a certain distance of each other. In some embodiments, a gesture that requires detection of movements that are too small to be detected may be flagged as being unavailable for one or more device, and may be subject to a lower rating based on the inability of the gesture to be implemented on certain devices. For instance, on a device that cannot distinguish points that are less than two centimeters from each other, if a developer defined “pinch to nothing” as the user placing two fingers and pinching them together until less than one centimeter separates the touches, the system would flag it as being unavailable on the given device. Conversely, if the “pinch to nothing” as the user placing two fingers and pinching them together until less than three centimeter separates the touches, the system may flag the expanded definition as being too broad/similar to another gesture (e.g., regular pinch-zoom), and may be subject to a lower rating based on the inability of the gesture to be readily distinguished from other gestures. Conversely, a rating may be higher for a gesture that falls within acceptable minimum detail ranges and is readily distinguished from other gestures. Such a minimum detail analysis may be provided as an aspect of geometric analysis of geometric definitions, and may be provided by geometry analyzer 106.

Latency may characterize a delay between a user input and recognition of the gesture associated with the input. As delay increases, the user experience is often negatively impacted as a user must wait longer for the anticipated response by the device. Latency may be increased with more complex gestures that require additional processing and may be decreased with simplified gestures that require less time. Thus, complex gestures may be subject to a lower rating, whereas simple gestures may be subject to a higher rating. In some embodiments, the characterization of latency may be subject to modifications based on the device as well as current trends. For example, as the speed of devices (e.g., processors) increases, complex gestures may not be subject to lower ratings due to the fact that latency has been effectively reduced for the gesture. Such an improvement in rating may be seen for all gestures as increased processing speeds effectively reduce the impact of latency and, thus, reduce the negative impact on the ranking of gestures due to latency. Further, in some embodiments, the effective impact of latency may be tuned/adjusted based on user perceptions or other factors. In some embodiments, as processing power increases and users are more accustomed to faster processing, users may expect latency to be small. Accordingly, a threshold for acceptable levels of latency may be reduced (e.g., from two-hundred fifty milliseconds to one-hundred milliseconds) to reflect user desires. Thus, complex gestures associated with higher latency (e.g., above the threshold) may be subject to lower ratings, where as simple gestures associated with lower latency may be subject to higher ratings. As is apparent, the relationship between processing power and user expectations may increase in a similar relationship such that the increases in processing power may be offset by user expectations of reduced latency, such that the rankings of gestures relative to one another may not change drastically, and thus, latency may have a consistent impact on the rating of gestures. Such a latency analysis may be provided as an aspect of time-based analysis of geometric definitions, and may be provided by geometry analyzer 106.

Extended event properties may be indicative of a gesture's dependence on properties, such as detection of pressure, contact area, detailed contact outlines, count of touches and/or location of touches. Although some devices may provide for sensing and processing an increasing number or even all of these and other extended event properties, some devices may be limited to sensing and processing only some or even none of the extended properties. In some embodiments, gestures that require sensing and/or processing of an increasing number of extended event properties may be subject to a lower rating than gestures that require sensing and/or processing of a fewer number of extended event properties. Such an extended event properties analysis may be provided as an aspect of geometric and and/or time-based analysis of geometric definitions, and may be provided by geometry analyzer 106.

Other gross characteristics required of a gesture may include direct view vs. indirect view, precision of targeting, precision of adjustment, speed of adjustment, and available ranges of adjustment. Direct view/touch may refer to a system where the display surface and the input surface (or display space and input space) are coincident and closely aligned, or calibrated. In these systems, the input and screen space may share a 1:1 mapping across the display. Coordination of individual touch points may be simple as the physical finger or stylus defines the target directly. Indirect view/touch may refer to a system where the display surface and input surface (or display space and input space) are not coincident. For example, the touchpad on a typical laptop is associated with the screen on that laptop, but the user interacts indirectly with the screen through a touchpad. In such an embodiment, a user touching the screen generally has no effect. That is, the user generally cannot directly press a button depicted on the screen, but must do so indirectly by moving a mouse pointer with the trackpad. Coordination of individual touch points may be complicated by the fact that a single mouse pointer is displayed on the screen and its motion is not absolute, but is merely an accumulation of relative motion sensed at the touchpad. Certain touches on a touchpad may not be mapped into screen space. Indirect touch systems may have inconsistent alignment, calibration, and scale between devices of the same make and model, users of the same device, or even the same user standing in a different place while using the same device. Multi-touch gestures may be executed on a direct or indirect touch device. Spatial gestures may be executed by the user of an indirect-sensing gesture recognition system. A gesture that is scale-independent may be implemented in a similar manner on direct and indirect systems.

Precision of targeting may take into consideration of the user's ability to begin this gesture at a particular location on the screen. For example, precision of targeting may take into account whether the gesture requires a user to perform the gesture from a limited portion of the screen, thereby making the gesture easier to recognize when entered correctly, but potentially more difficult to enter correctly. A gesture that is negatively affected by a precision of targeting may be subject to a lower ranking and vice versa. In some embodiments, precision of targeting may be provided via a statistical calculation based on test data. In some embodiment, heuristics may be provided as a consideration for precision of targeting. Precision of adjustment may take into account the user's ability to make an adjustment correctly. For example, is the user afforded an opportunity to modify or re-input a gesture after realizing it was not input correctly. A gesture that is negatively affected by a precision of adjustment may be subject to a lower ranking and vice versa. In some embodiments, precision of adjustment may be provided via a statistical calculation based on test data. Speed of adjustment may take into account the time in which a user is able make corrections to a gesture. For example, speed of adjustment may reflect whether or not the user is afforded a reasonable time period in which to modify or re-input a gesture after realizing it was not input correctly. A longer time period for correction may help to increase a raking for the gesture for one or more devices as the user is afforded an opportunity to cure mistakes. A gesture that is negatively affected by a shorter time for adjustment may be subject to a lower ranking. In some embodiments, speed of adjustment may be provided via a statistical calculation based on test data. Available ranges of adjustment may take into account the time available to the user for adjustments to the gesture. Depending on the geometry and gesture definition, this may be due to the total size of the device, the typical span of a human hand, or the minimum touch separation available on a device. For example, devices may have a limited screen size that limits changes to a gesture. A gesture that is negatively affected by a limited range of adjustment may be subject to a lower ranking and vice versa. In some embodiments, available range of adjustment may be provided via a statistical calculation based on test data.

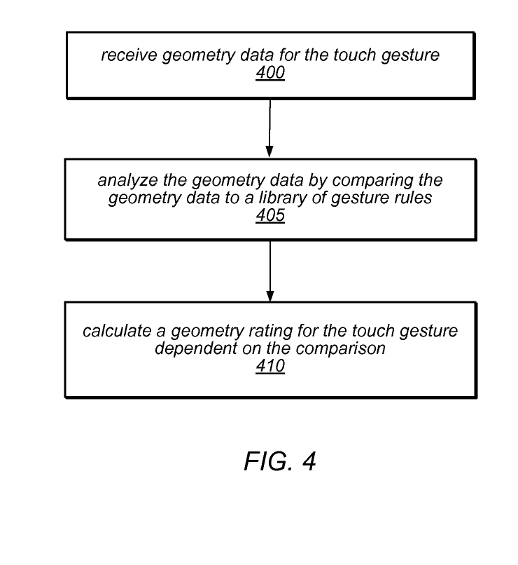

FIG. 4 illustrates a method that may be implemented by geometry analyzer 106 to calculate a geometry rating for a touch gesture. As indicated at 400 of FIG. 4, geometry analyzer 106 may receive geometry data (e.g., gestural data 102) for a touch gesture. The geometry data for the touch gesture may indicate the physical characteristics of the touch gesture. The geometry data received by geometry analyzer 106 (e.g., gestural data 102) may, in various embodiments, be different data types. As an example, gestural data 102 may be a definition of the touch gesture that is expressed in a gesture definition language. A gesture development tool, such as described in U.S. application Ser. No. 12/623,317 entitled “System and Method for Developing and Classifying Touch Gestures” filed Nov. 20, 2009, the content of which is incorporated herein in its entirety, may generate a definition of a touch gesture using a gesture definition language. For example, a gesture development tool may provide a mechanism for a gesture developer to represent a gesture using the gesture definition language.

A gesture definition language may define various elements which may represent the physical characteristics of a touch gesture. The gesture definition language may contain graphical elements that represent various touch gesture parameters. The gesture definition language may, for example, contain a set of icons, with each icon representing a gesture parameter or characteristics of a gesture parameter. For example, an icon depicting an upward-facing arrow may represent an upward trajectory for a touch gesture motion. The gesture definition language may also contain various other graphical representations of touch gesture parameters. For example, the gesture definition language may contain various curves and lines that a developer may combine to form a touch gesture. In a manner analogous to musical notation, the graphical elements of the gesture definition language may be various symbols (e.g., icons and/or other representations as described above) placed on a timeline. As with musical notes depicted in sheet music, the elements of the gesture definition language may be presented on the timeline in a manner that represents the relative timing of the multiple gesture parameters that form a complete gesture. For example, a symbol on a timeline may indicate that a particular parameter of a gesture (e.g., one finger down at a particular set of coordinates) occurs for a certain amount of time (e.g., one to two seconds). In such an example, the timeline of the gesture definition language may further indicate that a next gesture parameter (e.g., a horizontal swipe of the finger) may occur a certain amount of time (e.g., two to three seconds) after the preceding parameter.

Dependent on the physical characteristics of the touch gesture that are represented in the gesture definition language, the gesture development tool may create a gesture descriptor which represents the touch gesture. The gesture descriptor may be a unique representation of the touch gesture. The gesture descriptor may be formed by the gesture development tool as a software vector structure, where each element of the vector may be a set of values representing a particular physical characteristic of the touch gesture over time. The gesture development tool may create a software recognizable representation of each physical characteristic value and store each representation in a designated element of the vector. As an example, element 0 of a gesture descriptor vector may represent the “number of touch points” characteristic for the touch gesture.

The gesture descriptor vector may be stored by the gesture development tool and made available for use by geometry analyzer 106 of gesture evaluator 100.

As another example, gestural data 102 received by geometry analyzer 106 may be raw touch gesture data which may represent touch events applied to, or proximate to, the surface of a touch-enabled device. As an example, gesture evaluator 100 may include a touch-enabled device which may be configured to receive a touch gesture via a user application of the touch gesture to a touch-enabled surface. In such an example, a user may apply a touch gesture to the touch-enabled surface of gesture evaluator 100, or coupled to gesture evaluator 100, and may request, via an interface of gesture evaluator 100, a usability rating for the touch gesture. A device driver of the touch-enabled device, or the operating system running on the touch-enabled device, may capture the raw touch gesture data from the surface of the touch-enabled device. The touch gesture data (e.g., gestural input 102) may be sent, or made available, by the device driver to gesture evaluator 100. The touch gesture data may represent various physical characteristics of the touch gesture, dependent on the capabilities of the touch-enabled device.

The touch gesture data may include a plurality of touch events and each touch event may be represented by multiple spatial coordinates. For example, a stationary touch event may be represented by a set of proximate coordinates which represent the area covered by a stationary touch gesture. A mobile touch event may be represented by a set of coordinates which represent the gesture's motion across the surface of the touch-enabled device. Accordingly, a touch gesture data set may include a plurality of spatial coordinates.

The device driver of a touch-enabled device, or an operating system for gesture evaluator 100, may create a software recognizable representation of each spatial coordinate captured for the touch gesture. Each representation of a spatial coordinate may, for example, include a horizontal component (e.g., an “x” component), a vertical component (e.g., a “y” component), and an offset component (e.g., a “z” component) which identify a location of the gesture relative to a sensor. For example, a touch gesture on the surface of the touch-enabled device may be represented by an x-y coordinate. Such a touch gesture may include a “z” component of zero indicative of the gesture occurring at or substantially at the surface of the screen. Where the gesture includes only a two-dimensional input, such as that provided via contact with a touch-screen, it may not be necessary to include the “z” coordinate as it may be assumed to be zero. In an embodiment that includes recognition of a gesture that includes non-touch gesture components, the “z” component may be included to provide an indication of the location of the gesture relative to the sensor (e.g., offset some distance from the surface of the touch-screen). A device driver, or operating system, may form a software vector structure which may contain the multiple coordinate pairs that represent the spatial coordinates of a touch gesture. Each element of the software vector may contain a pair of coordinate values, for example, an (x,y) pair or (x,y,z) pair of coordinate values. Each coordinate pair may also be associated with a unique identifier that distinguishes each event (e.g., touch and/or non-touch event) from other events of the gesture. Each individual event of a gesture may be represented in the software vector by a spatial coordinate pair and a unique identifier. In some embodiments, one or more of the events may be associated with an input type. For example, each event may be associated with an input technique/device, such as a finger, limb, stylus, prop, or the like. For example, a touch event may be associated a user's fingertip or a stylus based on a profile (e.g., size or shape) of the contact interface. Thus, gestures may be characterized bases on the input device as well as other characteristics, such as the geometry of the gesture and/or other characteristics described herein.

As described above geometry analyzer 106 may receive, or access a stored version of, data which represents the physical characteristics of a touch gesture in the form of a gesture definition language expressed as a gesture descriptor, or raw touch event data. In other embodiments, other representations of the physical characteristics of a touch gesture are possible. For example, the physical characteristics of the touch gesture may be represented by software program code. Dependent on the data, geometry analyzer 106 may determine various physical characteristics of the touch gesture. For example, geometry analyzer 106 may determine physical characteristics of a touch gesture such as the number of touch points of the gesture, the spatial distance between each of the touch points of the gesture, and the number of changes in direction in the path of the gesture.

The number of touch points of a gesture may be represented by a value within a particular element of the gesture descriptor software vector. For example, as described above, element 0 of the gesture descriptor software vector may contain a value which indicates the number of touch points of a gesture. The number of touch points of a gesture, as another example, may be equivalent to the number of coordinate pairs present in the touch event data for a gesture. As described above, each touch point of a gesture may be represented by a coordinate pair in a set of touch event data for the gesture. Accordingly, the number of coordinate pairs in a set of touch event data for a gesture may be equivalent to the number of touch points of the gesture.

The spatial distance between the touch points of a touch gesture may be determined by calculating the distance between the coordinates of the touch points of the gesture. Note that touch gestures may be stationary or mobile and that multi-touch gestures may include any combination of mobile and/or stationary touch gestures. The spatial position of a stationary touch gesture may be represented by a set of coordinates which indicate the surface area of the touch that is applied. The trajectory of a mobile touch gesture may be represented by a set of coordinates which indicate the path of the mobile touch gesture across the surface. A calculation of the distance between touch points may first determine the appropriate coordinates to be used in a distance calculation. For example, the distance between two stationary touches may be calculated using the center coordinates of the two stationary touches. In an alternative embodiment, the distance between two stationary touches may be determined by calculating the distance between the pair of coordinates (e.g., one set of coordinates from each one of the stationary gestures) of the two touches that are in closest proximity.

Geometry analyzer 106 may also use the coordinate data set for a mobile touch gesture, to evaluate the path of the mobile gesture. The coordinates for a mobile touch gesture may indicate the trajectory of the mobile gesture as the gesture is applied to a touch-enabled surface. Geometry analyzer 106 may evaluate the set of coordinates to determine the number of changes in direction of the mobile touch gesture. The examples of physical characteristics of a touch gesture that may be determined by geometry analyzer 106 as provided as examples and are not meant to be limiting. In alternate embodiments, other physical characteristics of a touch gesture may be determined in order to rate the geometry of the gesture.

A library of gesture rules may indicate a number of rules, or guidelines, that a touch gesture may follow such that the touch gesture may be successfully executed by typical users. The library of gesture rules may be based on prior user testing of touch gestures and may specify the desired physical characteristics of touch gestures. For example, the gesture rules may specify a maximum number of touch points for a touch gesture. As another example, the gesture rules may specify a minimum distance between touch points. As yet another example, the gesture rules may specify a maximum number of direction changes for a touch gesture. The examples of physical characteristics of a touch gesture that may be represented in a library of gesture rules are provided as examples and are not meant to be limiting. Gesture evaluator 100 may include additional gesture rules.

As indicated at 405 of FIG. 4, geometry analyzer 106 may analyze the geometry data for the touch gesture by comparing the geometry data (e.g., the physical characteristics) to the library of gesture rules. For example, the number of touch points of a gesture may be compared to the maximum number of touch points specified by the library of gesture rules. The distance between each of the touch points of a gesture may be compared to the minimum distance specified by the library of gesture rules. The number of direction changes of a touch gesture may be compared to the maximum number of changes specified by the library of gesture rules.

As indicated at 410 of FIG. 4, geometry analyzer 106 may calculate a geometry rating for the touch gesture dependent on the comparison of the geometry rules for the touch gesture to the library of gesture rules. Geometry analyzer 106, in various embodiments, may use different methods to calculate the geometry rating for the touch gesture. As an example, geometry analyzer 106 may use a binary value for the geometry rating. The geometry rating of the touch gesture may be one of two options. The options may be ratings such as “poor” or “good,” for example, or the options may be represented by numerical values, such as 0 and 1. In such an example, if any one of the physical characteristics of the touch gesture does not meet the guidelines of the gesture rules, geometry analyzer 106 may assign a rating of “poor” (or an equivalent numerical value) to the geometry of the gesture. A rating of “good” (or an equivalent numerical value) may be assigned to the geometry of the gesture if all of the physical characteristics of the gesture meet the guidelines of the gesture rules. As another example, geometry analyzer 106 may calculate the geometry rating of a touch gesture based on a percentage of the physical characteristics which meet the guidelines of the gesture rules. For instance, if 8 out of 10 physical characteristics of the gesture meet the guidelines of the gesture rules, the gesture may be given a geometry rating of 80%.

Returning to FIG. 3, as indicated at 305, the method illustrated in FIG. 3 may include calculating a similarity rating for the touch gesture. Similarity analyzer 108 may calculate the similarity rating for the touch gesture. To calculate the similarity rating for the touch gesture, similarity analyzer 108 may compare the touch gesture to a number of other touch gestures. For example, similarity analyzer 108 may receive geometry data for the other touch gestures and may compare the geometry data for the other touch gestures to the geometry data for the touch gesture for which a similarity rating is being calculated. More specifically, similarity analyzer 108 may compare the gesture descriptor for the touch gesture to a set of gesture descriptors for the other touch gestures.

Similarity analyzer 108 may perform the touch gesture comparison to determine how distinct the touch gesture may be from other touch gestures. Touch gestures that are very similar (e.g., have closely matched gesture descriptors) may be “ambiguous” gestures. More specifically, the touch gestures may be ambiguous because the touch gesture may be so similar that it may be very difficult to distinguish between the touch gestures. Touch gestures that are difficult to distinguish may lead to errors or misinterpretation of user intentions, as one touch gesture may easily be interpreted as a given gesture by one gesture recognizer and interpreted as another touch gesture by another touch gesture recognizer.

The library of gesture rules may contain a set of guidelines which may indicate similar gesture characteristics that may result in ambiguous gestures. Similarity analyzer 108 may compare two touch gestures and evaluate the similarity between the two touch gestures based on the guidelines from the library of gesture rules. As an example, the gesture rules may specify that using two digits moving in a same direction in two different gestures may result in ambiguity between the two different gestures. In such an example, geometry analyzer 106 may provide an alert upon detection of two touch gestures which both include two digits moving in a same direction. Dependent on the number of alerts issued for similar touch gestures, geometry analyzer 106 may calculate a similarity rating for the touch gesture.

In some embodiments, gestures may be ranked based on a specialization of the gesture. Although a gesture maybe similar to another gesture, it may be defined in a specialized/different context that enables the two gestures to be distinguished. For example, a click and a double click, although similar may be distinguished by the context of the time frame in which the gestures are entered. That is, a single click over a given amount of time may be distinguished from a first and a second click that occur within the same amount of time. In some embodiments, a context may include a given application. For example, where the a first gesture is available only in a first application and a second gesture (similar to the first gesture) is available only in a second application, the context of use in the first or second application may enable the gestures to be distinguished from one another, and thus readily identified. In some embodiments, gestures that are associated with a specialized context may be afforded a higher ranking whereas gestures that are not associated with a specialized context may be subject to a lower ranking This may be reflective of their being more criteria by which to distinguish the specialized gesture over other/similar gestures and fewer criterions by which to distinguish the non-specialized gesture over other/similar gestures.

As indicated at 310, the method illustrated in FIG. 3 may include calculating a repeatability rating for the touch gesture. Repeatability analyzer 110 may calculate the repeatability rating for the touch gesture. Repeatability analyzer 110 may receive test data that represents multiple user executions of the touch gesture. For example, repeatability analyzer 110 may receive gestural data 102, which may be the results of real-time user tests. The real-time user tests may include a group of users repeatedly executing one or more touch gestures. The real-time user tests may be conducted in order to determine users' ability to successfully repeat execution of the one or more touch gestures. As an example, gestural data 102 may be touch event data that corresponds to multiple executions of the touch gesture. Repeatability analyzer 110 may analyze the touch event data for a particular touch gesture to determine how often users successfully executed the particular touch gesture. Dependent on the analysis of the touch event data, repeatability analyzer 110 may determine a repeatability rating for the touch gesture.

The repeatability rating for the touch gesture may be determined dependent on various metrics from the touch event data gathered in real-time user testing. For example, the repeatability rating may be determined dependent on a number of times (or a percentage of times) a user was able to correctly execute a touch gesture. As another example, the repeatability rating may be dependent on a user's ability to apply a fine adjustment using a particular touch gesture. In such an example, usability evaluator may monitor an amount of time required for the user to execute the fine adjustment. The usability evaluator may also determine how close the user's result (from the execution of the touch gesture) was to a particular target value for the fine adjustment. Accordingly, repeatability analyzer 110 may evaluate the user's execution of the touch gesture dependent on the accuracy and precision of the touch gesture. Repeatability analyzer 110 may determine the repeatability rating dependent on the accuracy and precision of the touch gesture.

As indicated at 315, the method illustrated in FIG. 3 may include calculating, dependent on one or more of the geometry rating, the similarity rating, and the repeatability rating, a usability rating for the touch gesture. Gesture evaluator 100 may calculate the usability rating using a variety of methods in different embodiments. As an example, the usability rating may be an average of the geometry rating, similarity rating and repeatability rating of the touch gesture. As another example, the usability rating may be a weighted average of the geometry rating, similarity rating and repeatability rating of the touch gesture, with one or more of the ratings weighted more heavily in the average calculation.

Gesture evaluator 100 may calculate an accessibility rating for a touch gesture. The accessibility rating for a touch gesture may indicate a probability that a user with reduced motor skills will correctly execute the touch gesture. Based on a set of heuristics, such as a library of gesture rules, as described above, geometry analyzer 106 may determine whether the touch gesture is accessible to, or can be executed by, users with reduced motor skill levels. For example, the library of gesture rules may contain accessibility rules which apply to users with reduced motor skills or reduced manual dexterity. Geometry analyzer 106 may evaluate a touch gesture against the accessibility rules, using a method similar to that described above, in the gesture rules library to determine whether a touch gesture is accessible to users with reduced motor skills, or reduced manual dexterity.

In some embodiments, gesture evaluator 100 may provide suggestions for improving the proposed gesture. For example, upon providing the user with a usability rating, gesture evaluator 100 may also provide a suggestion that the user improve general or specific aspects of the proposed gesture. In some embodiments, gesture evaluator may provide an indication of the geometry, similarity, or repeatability rating. For example, where similarity is of concern, gesture evaluator may inform the user that the geometry and the repeatability is acceptable, along with an indication that the gesture is very similar to another gesture, thereby enabling the user to focus efforts on differentiating the gesture over another gesture as opposed to being left guessing what needs to be improved. In some embodiments, gesture evaluator 100 may provide a description or picture of the other gesture that is similar to enable the user to more efficiently design the gesture around the other gesture. In some embodiments, gesture evaluator 100 may provide suggestions for how to improve the proposed gesture. Gesture evaluator 100 may indicate strong points of the gesture, weak points of the gesture, and/or suggestions to improve the weak point of the gesture. For example, gesture evaluator 100 may display a modified proposed gesture that has a higher rating than the gesture proposed by the user.

The system for evaluating gesture usability may be implemented in any authoring application, including but not limited to Adobe® Flash Professional®, Abode® Flash Builder®, or Adobe® Flash Catalyst®. A gesture test system may, for example, be implemented as a stand-alone gesture test application, as a module of a gesture development application such as Adobe® Flash Professional®, Abode® Flash Builder®, or Adobe® Flash Catalyst®, as a plug-in for applications including image editing applications such as Adobe® Flash Professional®, Abode® Flash Builder®, or Adobe® Flash Catalyst®, and/or as a library function or functions that may be called by other applications. Note that Adobe® Flash Professional®, Abode® Flash Builder®, or Adobe® Flash Catalyst® are given as examples, and are not intended to be limiting.

### Example System

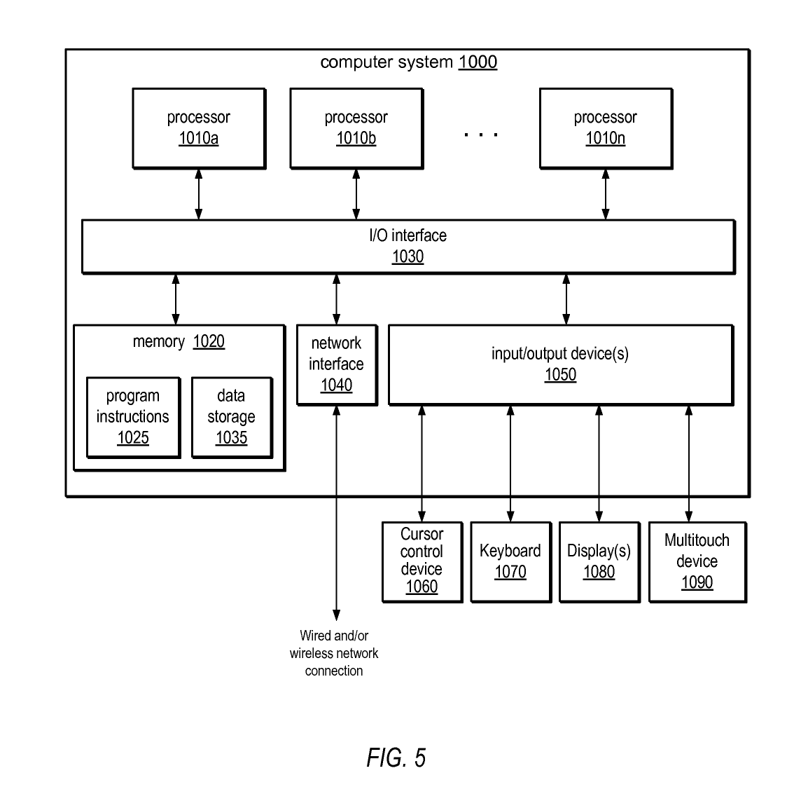

Various components of embodiments of methods as illustrated and described in the accompanying description may be executed on one or more computer systems, which may interact with various other devices. One such computer system is illustrated by FIG. 5. In different embodiments, computer system 1000 may be any of various types of devices, including, but not limited to, a personal computer system, desktop computer, laptop, notebook, or netbook computer, mainframe computer system, handheld computer, touch pad, tablet, workstation, network computer, a camera, a set top box, a mobile device, a consumer device, video game console, handheld video game device, application server, storage device, a peripheral device such as a switch, modem, router, or in general any type of computing or electronic device.

In the illustrated embodiment, computer system 1000 includes one or more processors 1010 coupled to a system memory 1020 via an input/output (I/O) interface 1030. Computer system 1000 further includes a network interface 1040 coupled to I/O interface 1030, and one or more input/output devices 1050, such as cursor control device 1060, keyboard 1070, multitouch device 1090, and display(s) 1080. In some embodiments, it is contemplated that embodiments may be implemented using a single instance of computer system 1000, while in other embodiments multiple such systems, or multiple nodes making up computer system 1000, may be configured to host different portions or instances of embodiments. For example, in one embodiment some elements may be implemented via one or more nodes of computer system 1000 that are distinct from those nodes implementing other elements.

In various embodiments, computer system 1000 may be a uniprocessor system including one processor 1010, or a multiprocessor system including several processors 1010 (e.g., two, four, eight, or another suitable number). Processors 1010 may be any suitable processor capable of executing instructions. For example, in various embodiments, processors 1010 may be general-purpose or embedded processors implementing any of a variety of instruction set architectures (ISAs), such as the x86, PowerPC, SPARC, or MIPS ISAs, or any other suitable ISA. In multiprocessor systems, each of processors 1010 may commonly, but not necessarily, implement the same ISA.

In some embodiments, at least one processor 1010 may be a graphics processing unit. A graphics processing unit or GPU may be considered a dedicated graphics-rendering device for a personal computer, workstation, game console or other computing or electronic device. Modern GPUs may be very efficient at manipulating and displaying computer graphics, and their highly parallel structure may make them more effective than typical CPUs for a range of complex graphical algorithms. For example, a graphics processor may implement a number of graphics primitive operations in a way that makes executing them much faster than drawing directly to the screen with a host central processing unit (CPU). In various embodiments, the methods as illustrated and described in the accompanying description may be implemented by program instructions configured for execution on one of, or parallel execution on two or more of, such GPUs. The GPU(s) may implement one or more application programmer interfaces (APIs) that permit programmers to invoke the functionality of the GPU(s). Suitable GPUs may be commercially available from vendors such as NVIDIA Corporation, ATI Technologies, and others.

System memory 1020 may be configured to store program instructions and/or data accessible by processor 1010. In various embodiments, system memory 1020 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing desired functions, such as those for methods as illustrated and described in the accompanying description, are shown stored within system memory 1020 as program instructions 1025 and data storage 1035, respectively. In other embodiments, program instructions and/or data may be received, sent or stored upon different types of computer-accessible media or on similar media separate from system memory 1020 or computer system 1000. Generally speaking, a computer- accessible medium may include storage media or memory media such as magnetic or optical media, e.g., disk or CD/DVD-ROM coupled to computer system 1000 via I/O interface 1030. Program instructions and data stored via a computer-accessible medium may be transmitted by transmission media or signals such as electrical, electromagnetic, or digital signals, which may be conveyed via a communication medium such as a network and/or a wireless link, such as may be implemented via network interface 1040.

In one embodiment, I/O interface 1030 may be configured to coordinate I/O traffic between processor 1010, system memory 1020, and any peripheral devices in the device, including network interface 1040 or other peripheral interfaces, such as input/output devices 1050. In some embodiments, I/O interface 1030 may perform any necessary protocol, timing or other data transformations to convert data signals from one component (e.g., system memory 1020) into a format suitable for use by another component (e.g., processor 1010). In some embodiments, I/O interface 1030 may include support for devices attached through various types of peripheral buses, such as a variant of the Peripheral Component Interconnect (PCI) bus standard or the Universal Serial Bus (USB) standard, for example. In some embodiments, the function of I/O interface 1030 may be split into two or more separate components, such as a north bridge and a south bridge, for example. In addition, in some embodiments some or all of the functionality of I/O interface 1030, such as an interface to system memory 1020, may be incorporated directly into processor 1010.

Network interface 1040 may be configured to allow data to be exchanged between computer system 1000 and other devices attached to a network, such as other computer systems, or between nodes of computer system 1000. In various embodiments, network interface 1040 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Input/output devices 1050 may, in some embodiments, include one or more display terminals, keyboards, keypads, touchpads, scanning devices, voice or optical recognition devices, or any other devices suitable for entering or retrieving data by one or more computer system 1000. Multiple input/output devices 1050 may be present in computer system 1000 or may be distributed on various nodes of computer system 1000. In some embodiments, similar input/output devices may be separate from computer system 1000 and may interact with one or more nodes of computer system 1000 through a wired or wireless connection, such as over network interface 1040.

As shown in FIG. 5, memory 1020 may include program instructions 1025, configured to implement embodiments of methods as illustrated and described in the accompanying description, and data storage 1035, comprising various data accessible by program instructions 1025. In one embodiment, program instruction 1025 may include software elements of methods as illustrated and described in the accompanying description. Data storage 1035 may include data that may be used in embodiments. In other embodiments, other or different software elements and/or data may be included.

Those skilled in the art will appreciate that computer system 1000 is merely illustrative and is not intended to limit the scope of methods as illustrated and described in the accompanying description. In particular, the computer system and devices may include any combination of hardware or software that can perform the indicated functions, including computers, network devices, internet appliances, PDAs, wireless phones, pagers, etc. Computer system 1000 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium. Accordingly, the present invention may be practiced with other computer system configurations.

Various embodiments may further include receiving, sending or storing instructions and/or data implemented in accordance with the foregoing description upon a computer-accessible medium. Generally speaking, a computer-accessible medium may include storage media or memory media such as magnetic or optical media, e.g., disk or DVD/CD-ROM, volatile or non-volatile media such as RAM (e.g. SDRAM, DDR, RDRAM, SRAM, etc.), ROM, etc., as well as transmission media or signals such as electrical, electromagnetic, or digital signals, conveyed via a communication medium such as network and/or a wireless link.

The various methods as illustrated in the Figures and described herein represent examples of embodiments of methods. The methods may be implemented in software, hardware, or a combination thereof. The order of method may be changed, and various elements may be added, reordered, combined, omitted, modified, etc. Various modifications and changes may be made as would be obvious to a person skilled in the art having the benefit of this disclosure. It is intended that the invention embrace all such modifications and changes and, accordingly, the above description to be regarded in an illustrative rather than a restrictive sense.

### Conclusion

Various embodiments may further include receiving, sending or storing instructions and/or data implemented in accordance with the foregoing description upon a computer-accessible medium. Generally speaking, a computer-accessible medium may include storage media or memory media such as magnetic or optical media, e.g., disk or

DVD/CD-ROM, volatile or non-volatile media such as RAM (e.g. SDRAM, DDR, RDRAM, SRAM, etc.), ROM, etc., as well as transmission media or signals such as electrical, electromagnetic, or digital signals, conveyed via a communication medium such as network and/or a wireless link.

The various methods as illustrated in the Figures and described herein represent examples of embodiments of methods. The methods may be implemented in software, hardware, or a combination thereof. The order of method may be changed, and various elements may be added, reordered, combined, omitted, modified, etc. Various modifications and changes may be made as would be obvious to a person skilled in the art having the benefit of this disclosure. It is intended that the invention embrace all such modifications and changes and, accordingly, the above description to be regarded in an illustrative rather than a restrictive sense.

1. A method for evaluating usability of a gesture, comprising:
prior to a computing device being enabled to convert the gesture into an event, determining a usability rating for the gesture comprising:
receiving geometry data for the gesture, that indicates physical characteristics of the gesture;
analyzing the geometry data for the gesture; and
calculating, responsive to said analyzing, the usability rating for the gesture based at least in part on a probability that the gesture will be executed correctly by a user;
recognizing the gesture on the computing device; and
converting the gesture into an event on the computing device.

2. The method of claim 1, wherein said analyzing comprises comparing the geometry data for the gesture to a library of gesture rules and calculating a geometry rating for the gesture dependent on the comparison, and wherein said calculating the usability rating for the gesture is based at least in part on the geometry rating for the gesture.

3. The method of claim 1, further comprising:
receiving geometry data for a plurality of gestures;
comparing the geometry data for the plurality of gestures to the geometry data for the gesture; and
calculating a similarity rating for the gesture based at least in part on said comparing;
wherein said calculating the usability rating for the gesture is based at least in part on the similarity rating.

4. The method of claim 1, further comprising:
receiving test data that represents a plurality of user executions of the gesture; and
calculating, based at least in part on the test data, a repeatability rating for the gesture;
wherein said calculating the usability rating for the gesture is based at least in part on the repeatability rating.

5. The method of claim 1, wherein the gesture corresponds to a touch gesture applied to a touch-sensitive surface of an electronic device.

6. The method of claim 5, wherein the physical characteristics of the touch gesture comprise one or more of a number of touch points of the touch gesture, coordinate positions of the touch points, and shape of the touch gesture.

7. The method of claim 1, wherein said calculating comprises calculating an accessibility rating for the gesture that indicates a probability that a user with reduced motor skills will execute the gesture correctly.

8. A computer-readable storage medium comprising instructions for a gesture evaluator that causes the gesture evaluator to:
prior to a computing device being enabled to convert a gesture into an event, determine the usability rating of the gesture comprising:
receiving geometry data for the gesture that indicates physical characteristics of the gesture;
analyzing the geometry data for the gesture;
determining a type of the computing device;
determining a set of characteristics of gestures that the type of the computing device supports; and
calculating, responsive to said analyzing, the geometry data for the gesture, the usability rating for the gesture based at least in part on a probability that the gesture will be executed correctly by a user and the set of characteristics of gestures that the type of the computing device supports;
recognize the gesture on the computing device; and
convert the gesture into an event on the computing device.

9. The computer-readable storage medium of claim 8, wherein said analyzing comprises comparing the geometry data for the gesture to a library of gesture rules and calculating a geometry rating for the gesture dependent on the comparison, and wherein said calculating the usability rating for the gesture is based at least in part on the geometry rating for the gesture.

10. The computer-readable storage medium of claim 8, wherein the gesture evaluator is further operable to:
receive geometry data for a plurality of gestures;
compare the geometry data for the plurality of gestures to the geometry data for the gesture; and
calculate, a similarity rating for the gesture based at least in part on said comparing;
wherein said calculating the usability rating for the gesture is based at least in part on the similarity rating.

11. The computer-readable storage medium of claim 8, wherein the gesture evaluator is further operable to:
receive test data that represents a plurality of user executions of the gesture; and
calculate, dependent on the test data, a repeatability rating for the gesture;
wherein said calculating the usability rating for the gesture is based at least in part on the repeatability rating.

12. The computer-readable storage medium of claim 8, wherein the gesture corresponds to a touch gesture applied to a touch-sensitive surface of an electronic device.

13. The medium of claim 12, wherein the physical characteristics of the touch gesture comprise one or more of a number of touch points of the touch gesture, coordinate positions of the touch points, and shape of the touch gesture.

14. The computer-readable storage medium of claim 8, wherein said calculating comprises calculating an accessibility rating for the gesture that indicates a probability that a user with reduced motor skills will execute the gesture correctly.

15. A system, comprising:
a memory; and
one or more processors coupled to the memory, such that the memory stores program instructions executable by the one or more processors to implement a gesture evaluator that during operation:
prior to a computing device being enabled to convert a gesture into an event, determines a usability rating of the gesture comprising:
receiving geometry data for the gesture that indicates physical characteristics of the gesture;
analyzing the geometry data for the gesture; calculating, responsive to said analyzing, the usability rating for the gesture based at least in part on a probability that the gesture will be executed correctly by a user;
receiving geometry data for a plurality of gestures;
comparing the geometry data for the plurality of gestures to the geometry data for the gesture; and
lowering the usability rating if the geometry data for the gesture is similar to geometry data for a one of the plurality of gestures;
recognizes the gesture on the computing device; and
converts the gesture into an event on the computing device.

16. The system of claim 15, wherein said analyzing comprises comparing the geometry data for the gesture to a library of gesture rules and calculating a geometry rating for the gesture dependent on the comparison, and wherein said calculating the usability rating for the gesture is based at least in part on the geometry rating for the gesture.

17. The system of claim 15, wherein the gesture evaluator further comprising:
calculate, dependent on the comparison, a similarity rating for the gesture based at least in part on said comparing;
wherein said calculating the usability rating for the gesture is based at least in part on the similarity rating.

18. The system of claim 15, further comprising:
receive test data that represents a plurality of user executions of the gesture; and
calculate, based at least in part on the test data, a repeatability rating for the gesture;
wherein said calculating the usability rating for the gesture is based at least in part on the repeatability rating.

19. The system of claim 15, wherein the gesture corresponds to a touch gesture applied to a touch-sensitive surface of an electronic device, and wherein the physical characteristics of the touch gesture comprise one or more of a number of touch points of the touch gesture, coordinate positions of the touch points and shape of the touch gesture.

20. The system of claim 15, wherein said calculating comprises calculating an accessibility rating for the gesture that indicates a probability that a user with reduced motor skills will execute the gesture correctly.
